(19) United States
(12) Patent Application Publication
(10) Pub. No.: US 2009/0217368 A1
(43) Pub. Date: Aug. 27, 2009

(54) SYSTEM AND METHOD FOR SECURE ACCOUNT RESET UTILIZING INFORMATION CARDS

(75) Inventors: Duane F. Buss, West Mountain, UT (US); Thomas E. Doman, Pleasant Grove, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/038,674

(22) Filed: Feb. 27, 2008

(51) Int. Cl. G06F 7/04

(52) U.S. Cl. 726/9

(57) ABSTRACT

New claim identifiers allow account reset and supplemental authorizations to be performed utilizing information cards. The new claim identifiers include claims for simple challenge questions, simple challenge answers, generated-challenge answers, and challenge methods. Each of the new claims can include a tuple. Methods of utilizing the new claim identifiers for account reset and supplemental authorization are also provided.

### RELATED APPLICATION DATA

This application is related to U.S. application Ser. Nos. 11/843,572; 11/843,638; 11/843,640; 11/843,608 and 11/843,591, all of which were filed Aug. 22, 2007 and claimed the benefit of U.S. application Ser. Nos. 60/895,312; 60/895,316; 60/895,325, all of which were filed Mar. 16, 2007; and is related to U.S. application Ser. No. 12/019,104, filed Jan. 24, 2008, which claimed the benefit of U.S. application Ser. No. 60/973,679 filed Sep. 19, 2007. All of the foregoing applications are herein incorporated by reference.

### FIELD OF THE INVENTION

This invention pertains to user account management, and more particularly to using information cards for account reset and supplemental authorization.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal for the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past year or two, the networking industry has developed the concept of information cards to tackle these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: 1) personal cards—or self-issued cards—and 2) managed cards—or cards that are issued by an identity provider. A personal card contains self-asserted identity information—the person issues the card and is the authority for the identity information it contains. The managed card is usually issued by an identity provider. The identity provider provides the identity information and asserts its validity.

When a user wants to release identity information to a relying party (for example, a web site that the user is interacting with), a tool known as a card selector assists the user in selecting an appropriate information card. When a managed card is selected, the card selector communicates with the identity provider to obtain a security token that contains the needed information. This interaction between the card selector and the identity provider is usually secure. The identity provider typically requests the user to authenticate himself or herself (for example, using a username/password, X.509 certificate, etc.) before it will return a security token. The security token can then be provided to the relying party.

Regardless of whether information cards are used or not, identity information requested by relying parties is typically associated with a specific account at the relying party, and often includes a username and a password. On occasion it becomes necessary for identity information associated with an account to be changed. This can occur because, for example, the user has forgotten the username or password associated with the account. To accommodate these situations, relying parties generally provide some means of account reset.

Also, on occasion, relying parties may wish to perform a supplemental authorization when a user logs into an account. This supplemental authorization can be used as part of a random check security scheme or in response to a policy, for example, a policy stating that supplemental authorization is required after a specified duration of inactivity on the account.

There are many common schemes used for account reset and supplemental authorization, but they often include asking the user a challenge question and then validating the user's response against an answer that was previously provided. The questions are usually designed so that a user can determine the appropriate response without specifically remembering what answer was given previously. Common questions include “What is your mother's maiden name?” and “What was your first pet's name?”.

Another common scheme is email-based password reset. Using this scheme, a user requests an account reset and the relying party emails the user their existing identity information, new identity information, or a credential that can be used to regain access to the account in order to change the identity information. The user can then use the information in the email to reset the account and/or regain access to the account.

Each of these account reset and supplemental authorization schemes is vulnerable, at least to some degree, to being spoofed. An attacker wishing to gain access to a user's account can simply use the account reset method to change the identity information and thereby gain access. Various sources of publicly available information, or even shoulder-surfing, can be used to aid the attacker in gaining access. If the attacker has access to the user's email account, any email-based account reset schemes are now available for the attacker to use to gain access. Consequently, conventional account reset and supplemental authorization schemes do not provide adequate security for user accounts.

Further, conventional account reset and supplemental authorization schemes are particularly susceptible to social engineering type attacks. These types of attacks are generally characterized by the fact that the attacker uses one piece of information about the victim to generate other information to aid in the attack. In an example of a social engineering attack, an attacker may know that a victim has an account at the Bank of Noplace. The attacker can then contact the victim, asserting to be from the Bank of Noplace, and convince the victim to provide account numbers and security information for the accounts. The attacker then has all of the information necessary to steal money from the accounts. This is a very rudimentary example of a social engineering attack: social engineering attacks are generally more sophisticated. However, the common characteristic with these types of attacks is that a small amount of information about the victim is used to generate enough information to attack the victim's secure accounts. Conventional account reset and supplemental authorization schemes are susceptible to this type of attack because if the attacker knows the name of the victim, the victim's mother's maiden name is not that difficult to find out from publicly available records. The same is true of other common challenge questions used in these schemes.

A need remains for a way to address these and other problems associated with the prior art.

### SUMMARY OF THE INVENTION

Embodiments of the invention have to do with performing account reset and supplemental authorization using information cards. Challenge claims can be provided to relying parties at account setup, during authorizations, or at other times. The relying parties can store the challenge claims and subsequently use the challenge claims for account reset and supplemental authorization. Challenge claims can also provide relying parties with a list of supported challenge methods.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows details of the computer system of FIG. 1.

FIG. 3 shows a sequence of communications between a client and a relying party according to conventional methods.

FIG. 4 shows a sequence of communications between a client, a relying party, and identity provider according to embodiments of the invention.

FIG. 5A shows a sequence of communications between a client, a relying party, and an identity provider according to embodiments of the invention.

FIG. 5B shows a sequence of communications between a client and a relying party according to embodiments of the invention.

FIG. 6 shows a flowchart of a procedure to provide simple challenge claims to a relying party according to an embodiment of the invention.

FIG. 7 shows a flowchart of a procedure to provide a generated-challenge claim to a relying party according to an embodiment of the invention.

FIG. 8 shows a flowchart of a procedure to establish generated-challenge answers at a relying party according to an embodiment of the invention.

FIG. 9 shows a flowchart of a procedure to respond to a challenge according to an embodiment of the invention.

FIG. 10 shows a flowchart of a procedure to provide a challenge method claim to a relying party according to an embodiment of the invention.

FIG. 11 shows a flowchart of a procedure to respond to a challenge according to an embodiment of the invention.

FIG. 12 shows a flowchart of a procedure to generate, store, and provide challenge claims according to an embodiment of the invention.

### DETAILED DESCRIPTION OF THE PREFERRED EMBODIMENT

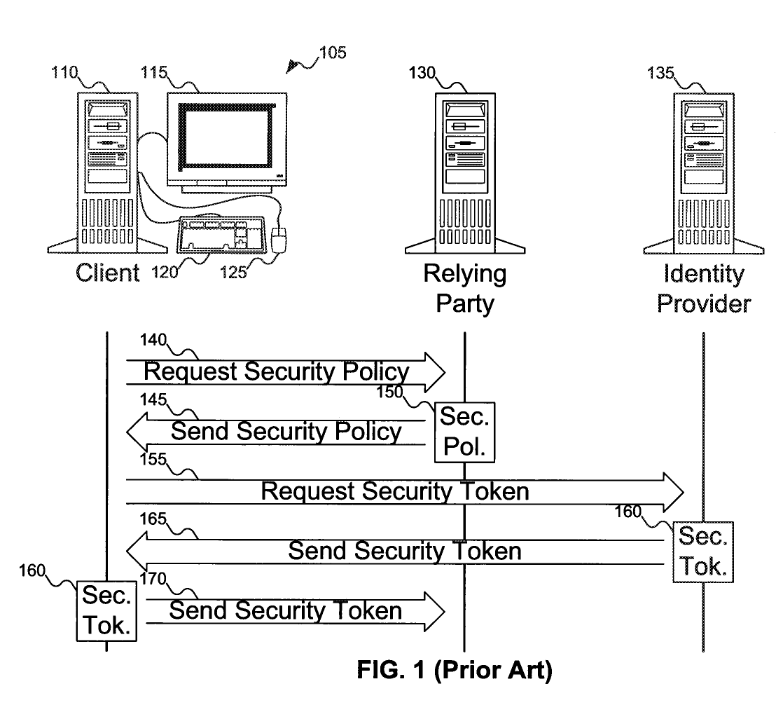

Embodiments of the invention utilize information cards to perform secure account reset and/or supplemental authorization. Consequently, before explaining the invention, it is important to understand the operation of an information card system. Such a system will be explained with respect to FIG. 1.

FIG. 1 shows a sequence of communications between a client, a relying party, and an identity provider. For simplicity, each party (the client, the relying party, and the identity provider) can be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of client 105; for example, a central processing unit, memory, storage, etc. Although not shown in FIG. 1, a person skilled in the art will recognize that client 105 can interact with other computer systems, such as relying party 130 and identity provider 135, either directly or over a network (not shown) of any type. Finally, although FIG. 1 shows client 105 as a conventional desktop computer, a person skilled in the art will recognize that client 105 can be any type of machine or computing device capable of providing the services attributed herein to client 105, including, for example, a laptop computer, a personal digital assistant (PDA), or a cellular telephone.

Relying party 130 is a machine managed by a party that relies in some way on the identity of the user of client 105. The operator of relying party 130 can be any type of relying party. For example, the operator of relying party 130 can be a merchant running a business on a website. Alternatively, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party 130. Depending on the type of information identity provider 135 stores for a user, a single user might store identifying information with a number of different identity providers 135, any of which might be able to satisfy the request of the relying party 130. For example, identity provider 135 might be a governmental agency, responsible for storing information generated by the government, such as a driver's license number or a social security number. Alternatively, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from relying party 130, client 105 requests the security policy of relying party 130, as shown in communication 140, which is returned in communication 145 as security policy 150. Security policy 150 is a summary of the information relying party 130 needs, how the information should be formatted, and so on.

Once client 105 has security policy 150, client 105 can identify which information cards will satisfy security policy 150. Different security policies might result in different information cards being usable. For example, if relying party 130 simply needs a username and password combination, the information cards that will satisfy this security policy will be different from the information cards that satisfy a security policy requesting the user's full name, mailing address, and social security number. The user can then select an information card that satisfies security policy 150.

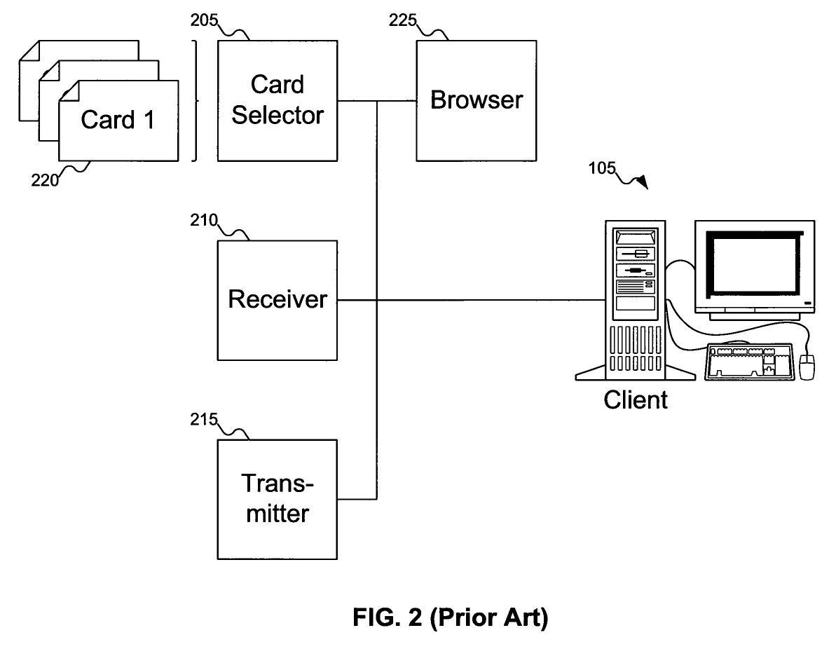

A card selector (described below with respect to FIG. 2) on client 105 can be used by the user to select the information card. The card selector can present the user with a list or graphical display of all available information cards and information cards that satisfy the security policy can be highlighted in some way to distinguish them from the remaining cards. Alternatively, the card selector can display only the information cards that will satisfy the security policy. The card selector can provide a means for the user to select the desired information card by, for instance, a mouse click or a touch on a touch screen.

Once the user has selected an acceptable information card, client 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 is usually encrypted in some manner, and perhaps signed and/or time-stamped by identity provider 135, so that relying party 130 can be certain that the security token originated with identity provider 135 (as opposed to being spoofed by someone intent on defrauding relying party 130). Client 105 then forwards security token 160 to relying party 130, as shown in communication 170.

In addition, the selected information card can be a self-issued information card (also called a personal card): that is, an information card issued not by an identity provider, but by client 105 itself. In that case, identity provider 135 effectively becomes part of client 105.

Often, the identity provider 135 takes the form of a web server, but this does not have to be the case. As an example, the identity provider 135 could be a Security Token Service (STS) that resides on the client 105, resides on the network, or even resides on a flash drive.

FIG. 2 shows details of the client of FIG. 1. Referring to FIG. 2, client 105 includes card selector 205, receiver 210, transmitter 215, and browser 225. Card selector 205 enables a user to select an information card 220 that satisfies the security policy described above with respect to FIG. 1. Card selector 205 also enables a user to obtain managed cards from identity providers and to install the managed cards on client 105. Receiver 210 receives data transmitted to client 105, and transmitter 215 transmits information from client 105. The receiver 210 and the transmitter 215 can facilitate communications between client 105 and, for example, relying party 130 and/or identity provider 135. The browser 225 allows the user to interact with web pages on a network: for example, web pages created by the identity provider 135 or the relying party 130.

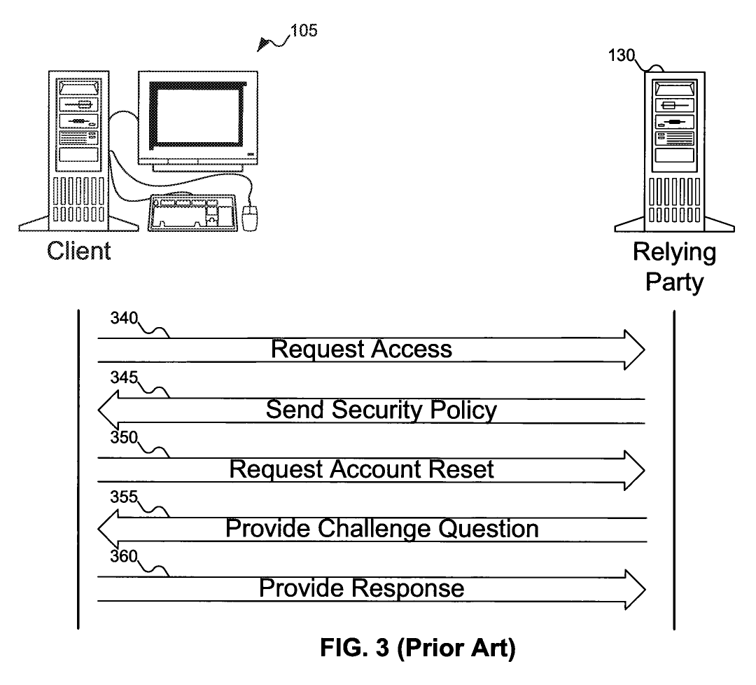

FIG. 3 shows a sequence of communications between a client and a relying party according to conventional methods. Referring to FIG. 3, a user on client 105 wishes to gain access to information on relying party 130. The client 105 sends an access request to relying party 130, as shown in communication 340. The relying party 130 then sends a request for identity information to the client 105, as shown in communication 345. The request 345 can include a web page containing a web-based form in which a user is prompted to fill in the identity information, for example, a username and password. For some reason, the user does not have the requested identity information and so instead sends a request for an account reset, as shown in communication 350. There are many possible reasons why the user does not have the identity information. For example, the user might have forgotten the identity information due to a long period of disuse. Upon receiving request 350, the relying party 130 initiates an account reset procedure. It should be noted that the user did not have to provide any identifying information in order to initiate the account reset.

For the purposes of this example, the relying party 130 can use the secret challenge question method of account reset. Relying party 130 supplies the question and requests an answer from the client 105, as shown in communication 355. The question can be, for example “What is your mother's maiden name?”. Assuming the user is able to remember the answer that was previously given in response to this question; the user provides a response as shown in communication 360. Note that the answer previously supplied by the user was not necessarily the correct answer to the question, and so the user must remember whether they previously supplied the correct answer to the question or, if not, what answer the user did supply. In other words, the user might have previously supplied the answer “Smith”, which is the actual maiden name of the user's mother, or the user might have supplied “2*toil”, which is not the user's mother's actual maiden name. The latter situation can arise when a user, recognizing the security flaw inherent in supplying publicly available information, chooses to supply a false answer instead. If the answer supplied by the user matches the previously supplied answer, the user will be given access to the desired information on relying party 130. Also, relying party 130 can supply the user with the old identity information or require the user to provide new identity information as part of the account reset process.

In this example, the relying party is using a challenge question scheme for account reset. However, there are many other common schemes, and many variations of the challenge question scheme, used for account reset and supplemental authorization. For example, the challenge question scheme in its most basic form simply asks a user to supply an answer to a preset question and the user has the option of either supplying the correct answer or supplying some other answer that the user will be able to recall at a later time, if called upon to do so. More advanced challenge question schemes allow a user to pick from a list of multiple questions or even allow a user to enter their own question. However, even the advanced forms of the challenge question scheme also have problems: the questions can often be answered with information that is available to the general public (e.g., mother's maiden name) or to acquaintances of the user (e.g., first pet's name) or information that can be obtained by shoulder-surfing (i.e. standing behind the user and watching the information entered on the display). Even if the answer is not readily ascertainable, this type of scheme reduces the problem of attacking the account from one of having to guess a username and/or password (which each could be any possible combination of letters, numbers, and special characters) to one of guessing a question response (which is likely to be drawn from a much smaller set including only names or dictionary words). Therefore, the challenge question scheme reduces the security of the account.

Other common techniques are based on email. In a basic email scheme, upon request, a user is sent their username or password through email so that the user can regain access to their account. In some cases, a temporary password can be sent to the user and the user may have to provide new identity information upon using the temporary password. There are many other possible variations of the email scheme and these will not be discussed further here. The important thing to note is that email accounts are also subject to attack (often by simply obtaining a username and password). If the attacker can guess the target user's email account login and password, the attacker can force a reset of the account and define the new password. Not only is the user denied access to his or her account, but the attacker is able gain access to the account. The email technique of account reset/supplemental authorization is potentially no more secure than an individual user's email account.

According to embodiments of the invention, new claim identifiers can be used by relying parties and identity providers to exchange challenge questions, challenge responses, challenge methods, and/or expected challenge response proof. The claims can be used in tuples and different claim tuples can have different security properties. Also, a single claim can include tuples. As used here, tuples refer to claims or claim elements that form a set. For example, a simple challenge answer claim and a simple challenge question claim together form a tuple. As a further example, a challenge claim can include a tuple comprising a claim element (such as a challenge method) and associated metadata (such as seed data). Not all claims are necessarily used or supported by all relying parties. Each of the individual relying parties can decide which claims it would like to support and use.

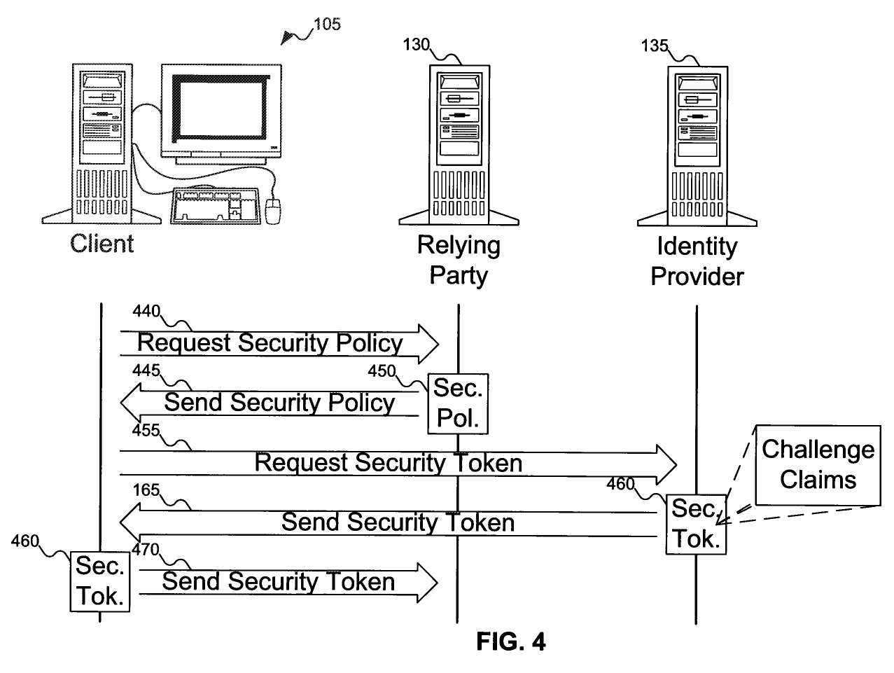

New claim identifiers for a simple challenge question scheme could take the form:
http://bandit-project.org/schemas/simple-challenge-question/{1-n}
http://bandit-project.org/schemas/simple-challenge-answer/{1-n}
   These claim identifiers could be used when the relying party wants to actually store the question and the response. Prior to establishing an account at a relying party, a user could obtain a managed card from an identity provider. When obtaining the managed card, the user could be prompted to enter one or more challenge questions and responses, which would become claims associated with the managed card. In this case, the user can provide the questions directly or the user can choose the questions from a list provided by the identity provider. When setting up an account at the relying party, the user does not need to establish a challenge question and response because the pre-selected challenge questions and responses can be provided to the relying party each time the user authenticates using the managed card, as described below with respect to FIG. 4.

The new claim identifiers can also be used with personal cards. As long as the card selector supports the new claim identifiers, a user can establish challenge questions and answers associated with the personal card through the card selector. These challenge questions and answers can then be provided to relying parties during authentication, similar to the case for managed cards described above.

Using these claim identifiers would be most like current implementations of challenge question schemes, in that the relying party stores the question and answer and the response is compared to the stored answer. It should be noted that the answer is also stored at the identity provider. The identity provider can store static strings and provide them to the relying party to be stored statically. In this case, if the user changes the answer at the identity provider, the new answer might not be updated at the relying party until the next time the claims are provided to the relying party, typically at authentication.

FIG. 4 shows a sequence of communications between a client, a relying party, and identity provider according to embodiments of the invention. Referring to FIG. 4, when a user wants to access some data from relying party 130, client 105 requests the security policy of relying party 130, as shown in communication 440, which is returned in communication 445 as security policy 450. Security policy 450 is a summary of the information relying party 130 needs, how the information should be formatted, and so on. Security policy 450 also includes the new claim identifiers for a simple challenge question and answer.

Once client 105 has security policy 450, the card selector can identify which information cards will satisfy security policy 450 and present them to the user. The user can then select an information card that satisfies security policy 450. Once the user has selected an acceptable information card, client 105 transmits a request for a security token to identity provider 135, as shown in communication 455. This request can identify that the challenge question and answer are to be included in the security token. Identity provider 135 returns security token 460, as shown in communication 465. Security token 460 includes claims containing the challenge question and the answer to the challenge question. Client 105 then forwards security token 460 to relying party 130, as shown in communication 470. Relying party 130 can then store the challenge question and answer. Relying party 130 can also store an identifier for the identity provider 135 that provided the security token. If the relying party 130 subsequently needs to issue the challenge question, for supplemental authorization or account reset, the relying party 130 has all of the information it needs to provide the challenge question, gather a response, and validate the response against the stored answer. Note that in this example, the user does not need to remember the answer to the challenge question because, when faced with the challenge question, the user can simply obtain the answer from the identity provider 135. Therefore, using these claim identifiers, the user's memory is not relied upon to secure the account. The challenge question and answer claims can be used in tuples. Also, a user might have to respond to more than one challenge from the relying party. In this case, a user can be authorized by correctly responding to only a subset of the total challenges posed.

As described above, the user can obtain the challenge answer from the identity provider in response to a challenge question from the relying party. The challenge question can be presented to the user from the relying party as a form for the user to fill in or as a request for a security token. In the case of a form, the user can request the challenge answer from the identity provider and then either type the answer into the form or copy/paste the answer into the form. In the case of a security token request, the relying party can keep track of which identity provider issued the challenge question and answer and require that the security token come from the same identity provider.

A person of ordinary skill in the art will appreciate that using these claim identifiers, the challenge questions and answers do not need to be natural language words or phrases; they can be any random string of characters. In this case, the challenge to the user might be unintelligible by the user, but the user can simply present the same challenge to the identity provider and the identity provider can then provide the user with the proper response. Note that responding to the challenge can be done automatically by the card selector without requiring interaction by the user. This approach is much more secure than conventional methods because it does not necessarily rely upon natural language questions and responses.

New claim identifiers for a generated-challenge-answer scheme could take the form:
http://bandit-project.org/schemas/generated-challenge-answer/{1-n}
   Using these claim identifiers, there is no need for a user question; instead the claim names suffice. These claims can use complex, randomly generated values that are not easily ascertainable using brute force attack methods. According to some embodiments, the claims can be hashed or made unique to individual relying parties. Making the claims unique to the relying parties will prevent loss of a secret at one relying party from affecting security at other relying parties. Making the claims unique to individual relying parties can also prevent the generated-challenge answer from becoming a multi-directional identifier which could be used by colluding relying parties to uniquely associate accounts and identify the user. However, it should be noted that having claims that are unique to a relying party means that the identity provider knows the relying party, which could compromise the user's identity if there is collusion between the identity provider and the relying party.

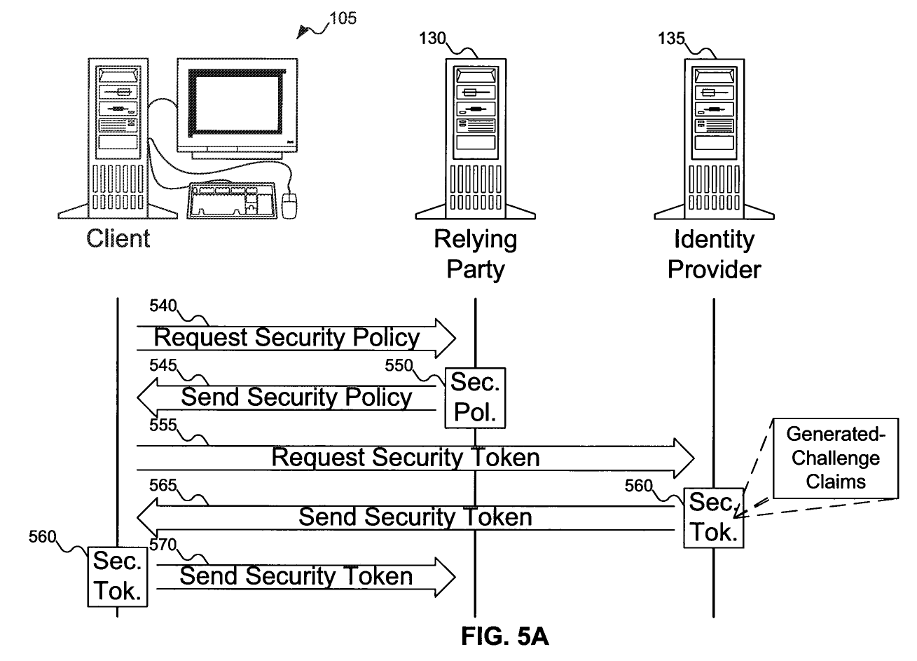

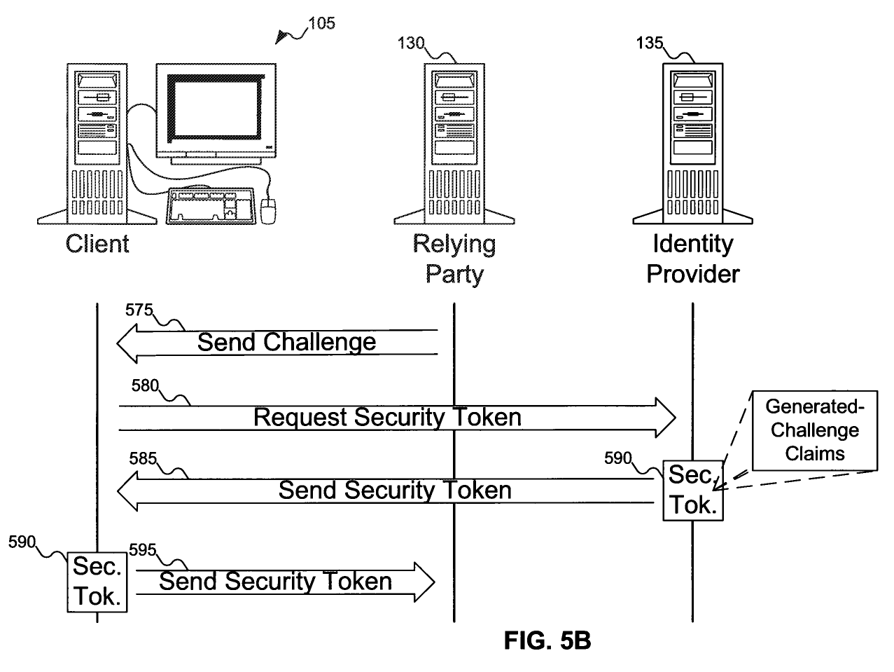

FIG. 5A shows a sequence of communications between a client, a relying party, and an identity provider according to embodiments of the invention. Referring to FIG. 5, when a user wants to access some data from relying party 130, client 105 requests the security policy of relying party 130, as shown in communication 540, which is returned in communication 545 as security policy 550. Security policy 550 is a summary of the information relying party 130 needs, how the information should be formatted, and so on. Security policy 550 also includes a new claim identifier for a generated-challenge answer.

Once client 105 has security policy 550, the card selector can identify which information cards will satisfy security policy 550 and present them to the user. The user can then select an information card that satisfies security policy 550. Once the user has selected an acceptable information card, client 105 transmits a request for a security token from identity provider 135, as shown in communication 555. This request can identify that the generated-challenge answer is to be included in the security token. Identity provider 135 returns security token 560, as shown in communication 565. Security token 560 includes a claim containing the generated-challenge answer. Client 105 then forwards security token 560 to relying party 130, as shown in communication 570. Relying party 130 can then store the generated-challenge answer. Relying party 130 can also store an identifier for the identity provider 135 that provided the security token. The claim containing the generated-challenge answer can also comprise a tuple such that several generated-challenge answers are provided to the relying party.

FIG. 5B shows a sequence of communications between a client and a relying party according to embodiments of the invention. Referring to FIG. 5B, if the relying party 130 needs to issue a challenge, for supplemental authorization or account reset, the relying party 130 sends a challenge to client 105, as shown in communication 575. The challenge can include an identifier for the identity provider 135 that has the generated-challenge answer. Once the user has selected an acceptable information card, which can be in response to the identifier provided by the relying party 130, client 105 transmits a request for a security token to identity provider 135, as shown in communication 580. Identity provider 135 returns security token 590, as shown in communication 585. Security token 590 includes a claim containing the generated-challenge response (or responses). Client 105 then forwards security token 590 to relying party 130, as shown in communication 595. Relying party 130 can then validate the generated-challenge response(s) against the stored generated-challenge answer(s).

Note that in this embodiment, the user did not have to remember the answers to any challenge questions because the secret is shared between the relying party and the identity provider rather than between the user and the relying party. Further, the generated-challenge answer(s) can be arbitrary strings of characters so that the user's account can be more secure relative to conventional methods.

A new claim identifier for a challenge method scheme could take the form:
http://bandit-project.org/schemas/challenge-method
   This claim can contain a list of challenge methods supported by the identity provider. Using this claim, the relying party can store a list of what challenge methods are supported by the identity provider. The relying party can also store an identifier for the identity provider that provided the challenge method claim. Depending on the supported challenge methods, the relying party can present additional claim requests to the identity provider. These additional claim requests can be presented before the need for account reset arises so that some seed data is exchanged before there is a need to rely on that seed data for an account reset. In other words, over the course of several interactions or during a single interaction, the user, through the identity provider, may present additional claims containing seed data to the relying party that can be used later in an account reset or supplemental authorization. It should be noted, though, that not all challenge methods will need seed data to be obtained. For example, challenge methods that depend on data about historical transactions between the relying party and the identity provider will not require collection of seed data because the identity provider and the relying party will develop and store the historical data over the course of multiple interactions. Also, the challenge method claim can include one or more tuples each comprising a challenge method and associated seed data. In this way, the seed data can be provided to the relying party along with the challenge method claim.

When it becomes necessary to do an account reset or supplemental validation, the relying party can choose one or more of the methods from the list and notify the identity provider, through the client, which method(s) are supported. As an example, the challenge method could take the form of an inquiry into information that is stored at both the relying party and the identity provider. The inquiry could be “What are the dates and times of your most recent five visits to this relying party?”. This information would generally be stored by the relying party and the identity provider would also have this information, provided an information card issued from the identity provider was used to authenticate the most recent five visits. In response to this challenge, the identity provider could provide the requested information and the relying party could use the provided information to validate the user. The relying party can validate the response against a stored answer, or the relying party can generate an answer (perhaps querying a database of user visit information) in order to validate the response. In this embodiment, the information provided is not necessarily secret, but it is also information that is not publicly known or readily ascertainable by parties other than the relying party and the identity provider. Consequently, this scheme is more secure than conventional methods. This is just one example of many possible challenge methods that could be used with this claim.

Further, using this claim, the challenge process can involve obtaining challenge responses from multiple identity providers. Under this approach, the likelihood of collusion between a relying party and any one identity provider can be reduced. The identity provider(s) used for the challenge process can also be a different identity provider than the one used to authenticate the client to the relying party. For example, when an account is created on a relying party, part of the account creation process can include entering an identifier for an identity provider, or identity providers, that will be used for account reset and supplemental authorizations.

A zero knowledge proof scheme can be implemented using the challenge method claim in which seeds are exchanged as claims. In this case, the seeds would not be the actual data requested by the relying party, but instead would be proof that the identity provider has the data. Such a zero knowledge proof method can include several interactions between the relying party and the client (which would interact with the identity provider) to establish the proof.

As an example of a zero-knowledge proof using information cards, an identity provider can provide a relying party, through the client, with a large graph, G, as seed data in a challenge method claim. The challenge method claim can include an identifier called “Hamiltonian” and this identifier may be known generally by relying parties and identity providers as referring to this type of zero-knowledge proof. Before providing G to the relying party, the identity provider calculates G and a Hamiltonian cycle for G that is not known to the relying party. The identity provider can also calculate G such that it is specific to the relying party. The relying party stores G for future use. It should be noted that G is not necessarily included in the challenge method claim. The relying party may request G from the identity provider, through the client, after receiving the challenge method claim including the Hamiltonian identifier and in response the identity provider can provide G to the relying party, through the client.

At some point, the relying party determines that it is time for an account reset or supplemental authorization. This begins a round of interaction cycles between the client and the relying party. The relying party provides a challenge to the client. The challenge can include an identifier for the identity provider that provided G to the relying party. A user selects an appropriate managed card and the card selector sends a request for a security token to the appropriate identity provider. The identity provider calculates H, which is an isomorphic graph to G. The identity provider returns H to the relying party, via the card selector. Next, the relying party randomly chooses one of two questions to ask the identity provider, through the client: prove the isomorphism between H and G; or provide a Hamiltonian cycle in H. Using known mathematical principles, the relying party can verify that the response to either of these questions is correct using only H and G. The relying party presents the selected question to the identity provider, through the card selector, and the calculated response is provided in a security token. The relying party then validates the response.

This cycle can be repeated any number of times until the relying party is convinced of the identity of the user and accepts the account reset or supplemental authorization. The number of times that the cycle will be repeated can be specified by the identity provider as part of the seed data provided with the challenge method claim. Alternatively, the number of cycles may be specified by the relying party. However, it should be noted that the relying party never learns the Hamiltonian cycle for G, which is what makes this a zero-knowledge proof.

This is just an example of a zero-knowledge proof that can be used with information cards and a person of ordinary skill in the art will recognize that other types of zero-knowledge proofs are possible. Although described above as a zero-knowledge proof between an identity provider and a relying party, zero-knowledge proofs can also be implemented between the relying party and the client in which the card selector issues the appropriate security tokens, rather than an identity provider. In other words, zero-knowledge proofs can be implemented using personal cards as well as managed cards.

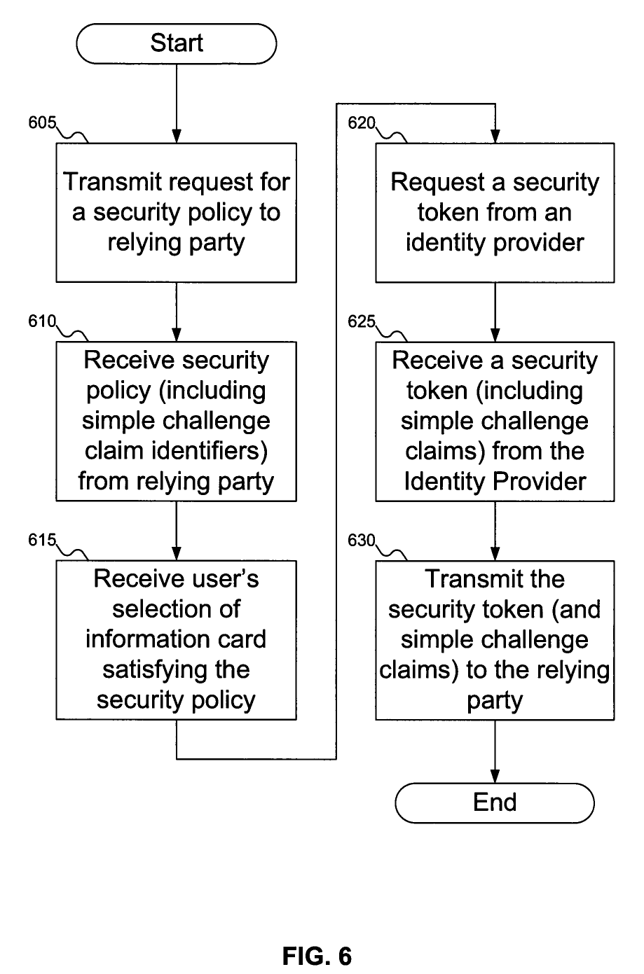

FIG. 6 shows a flowchart of a procedure to provide simple challenge claims to a relying party according to an embodiment of the invention. Referring to FIG. 6, at block 605, a request for a security policy is transmitted to the relying party from a client. The security policy is received from the relying party at block 610. The security policy includes claim identifiers for a simple challenge question and answer. An appropriate information card that can satisfy the security policy is then selected by a user at block 615. At block 620, a request for a security token is transmitted to the appropriate identity provider for the selected information card. This request indicates that the challenge question and answer are to be included in the security token. A security token is received from the identity provider at block 625. The security token includes claims containing the challenge question and the answer to the challenge question. At block 630, the security token is transmitted to the relying party. The relying party then validates the identity information in the security token and can then store the challenge question and answer. If the relying party subsequently needs to issue the challenge question, for supplemental authorization or account reset, the relying party has all of the information it needs to provide the challenge question, gather a response, and validate the response against the stored answer. Although this embodiment has been described in the context of only a single challenge question and answer, a person of ordinary skill in the art will appreciate that a plurality of challenge questions and answers can be used with the same method.

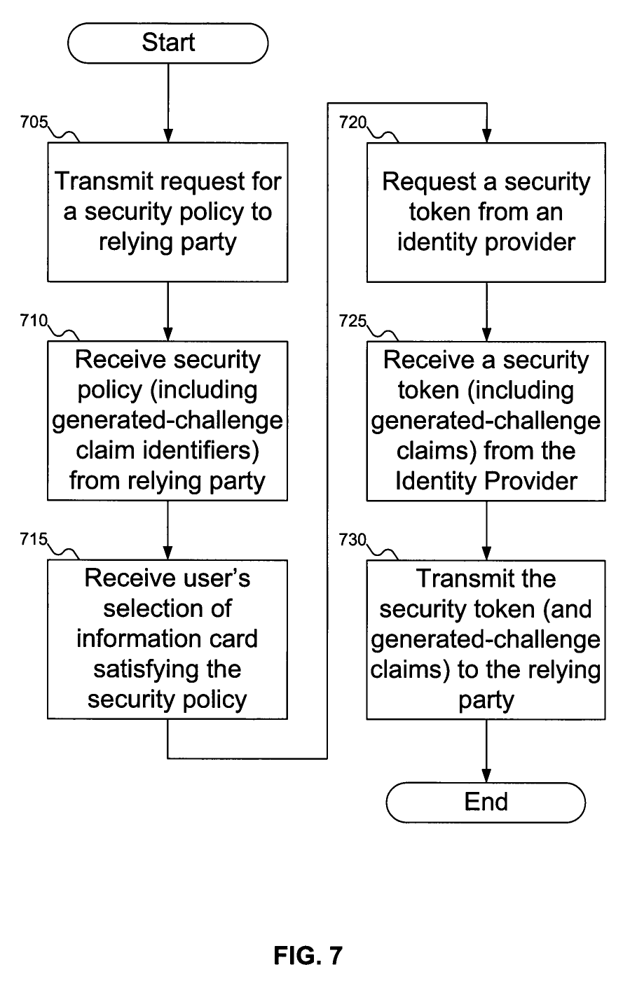

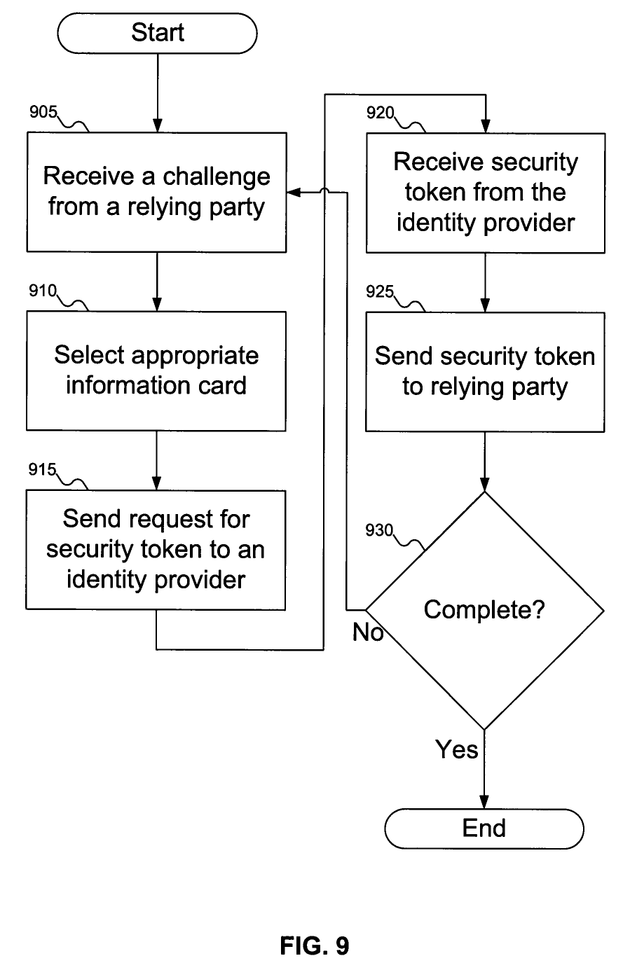

FIG. 7 shows a flowchart of a procedure to provide a generated-challenge claim to a relying party according to an embodiment of the invention. Referring to FIG. 7, at block 705, a request for a security policy is transmitted to the relying party from a client. The security policy is received from the relying party at block 710. The security policy includes a claim identifier for a generated-challenge answer. An appropriate information card that can satisfy the security policy is then selected by a user at block 715. At block 720, a request for a security token is transmitted to the appropriate identity provider for the selected information card. This request indicates that a generated-challenge answer is to be included in the security token. A security token is received from the identity provider at block 725. The security token includes a claim containing the generated-challenge answer. The generated-challenge answer can be a random string of characters. Alternatively, the generated-challenge answer can be a value that is calculated with respect to the relying party. At block 730, the security token is transmitted to the relying party. The relying party then validates the identity information in the security token and can then store the generated-challenge answer. If the relying party subsequently needs to challenge the user, for supplemental authorization or account reset, the relying party can simply request the generated-challenge answer from the user, gather a response, and validate the response against the stored answer, as further described below with respect to FIG. 9.

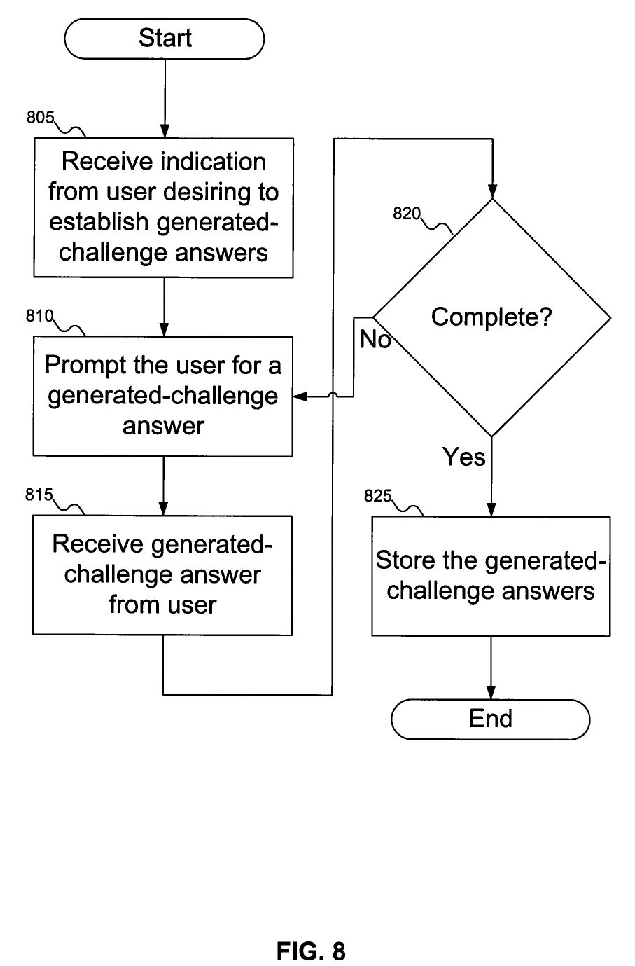

FIG. 8 shows a flowchart of a procedure to establish generated-challenge answers at a relying party according to an embodiment of the invention. Referring to FIG. 8, at block 805, a user indicates a desire to establish generated-challenge answers with a relying party. This desire can be in response to a prompt from the relying party and can be associated with initial setup of an account at the relying party or an update of an existing account. The relying party then prompts the user for a generated-challenge answer at block 810. The user obtains the generated-challenge answer from an identity provider and provides it to the relying party at block 815. Blocks 810 and 815 can be repeated one or more times. The number of repetitions can be a pre-set number determined by the relying party or it can be determined by the user, for example, by the user indicating to the relying party that the user is finished adding generated-challenge answers. Also, one or more identity providers can be used during the repetitions so that all of the generated-challenge answers do not come from the same identity provider. At block 820, a determination is made (by either the relying party or the user) if the process of entering generated-challenge answers is complete. If the process is not complete, the relying party again prompts the user for a generated-challenge answer at block 810. If the process is complete, the relying party stores the generated-challenge answers at block 825. If the relying party subsequently needs to challenge the user, the relying party can request the user to provide one or more of the generated-challenge answers and the relying party can validate the user's responses against the stored answers, as further described below with respect to FIG. 9.

FIG. 9 shows a flowchart of a procedure to respond to a challenge according to an embodiment of the invention. Referring to FIG. 9, at block 905, a user receives a challenge from a relying party. The challenge is a request for a generated-challenge answer that was previously provided to the relying party. The challenge can be prompted by the user as a request for an account reset or it may have originated with the relying party for the purpose of supplemental authorization. At block 910, the user selects an information card that is appropriate for responding to the challenge. In this case, because the relying party is requesting a security token, the relying party can specify an appropriate identity provider to provide the token (i.e., the identity provider that previously provided the generated-challenge answer to the relying party) and the user can select an information card corresponding to the appropriate identity provider. A request for a security token is then sent to the identity provider associated with the selected information card at block 915. A security token is received from the identity provider at block 920. The security token includes the response to the challenge. At block 925, the security token is transmitted to the relying party. The relying party can then validate the generated-challenge response against a stored generated-challenge answer. At block 930, the relying party determines if another challenge is to be sent. If the relying party determines that another challenge is appropriate, the procedure returns to block 905. This process can be repeated any number of times. Also, each time the process is repeated, the user can select a different information card and/or request a security token from a different identity provider. The relying party can validate the user even if the user is not able to provide proper responses for every challenge. For example, the user can be validated (i.e. the account reset is accepted or the supplemental authorization is approved) if n correct answers are provided out of m challenges. The values of n and m can be determined by the relying party or by the user during account setup, for example.

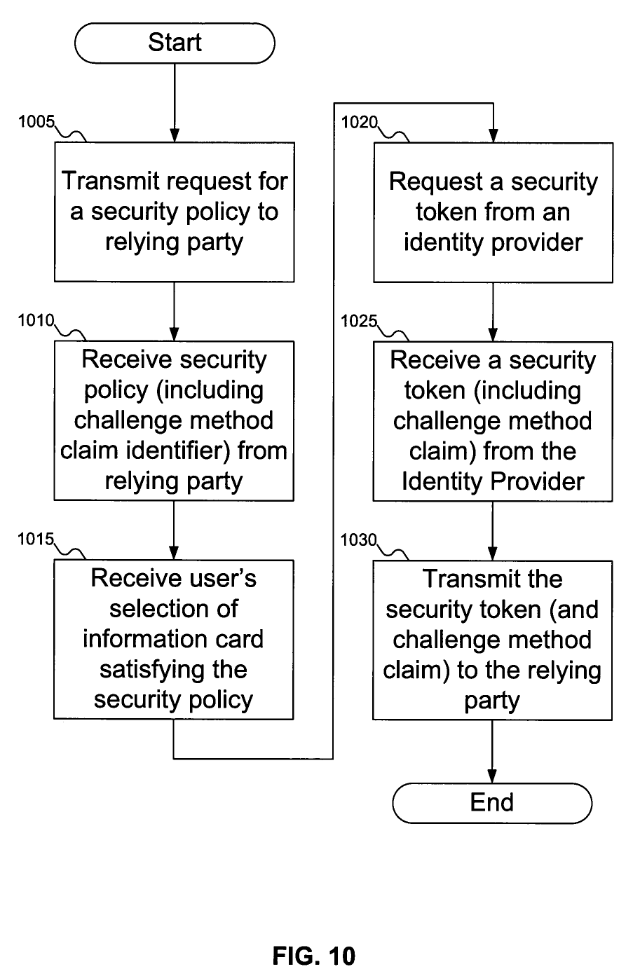

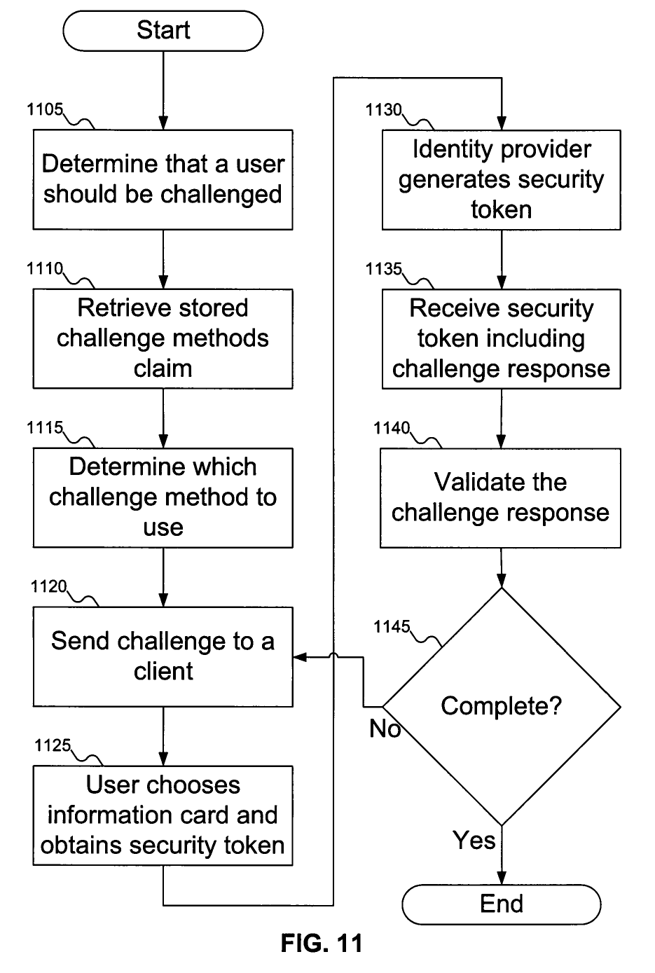

FIG. 10 shows a flowchart of a procedure to provide a challenge method claim to a relying party according to an embodiment of the invention. Referring to FIG. 10, at block 1005, a request for a security policy is transmitted to the relying party from a client. The security policy is received from the relying party at block 1010. The security policy includes a claim identifier for challenge methods. An appropriate information card that will satisfy the security policy is then selected by a user at block 1015. At block 1020, a request for a security token is transmitted to the appropriate identity provider for the selected information card. This request indicates that challenge methods are to be included in the security token. A security token is received from the identity provider at block 1025. The security token includes at least one claim containing the challenge methods. The challenge methods can be a list of identifiers that correlate to known (by relying parties) challenge methods. The challenge method claim can include one or more tuples to provide seed data to the relying party along with the associated challenge methods. At block 1030, the security token is transmitted to the relying party. The relying party then validates the identity information in the security token and can then store the challenge methods. Depending on the challenge methods identified in the claim, the relying party may obtain seed data from the identity provider through further interactions with the identity provider. If the relying party subsequently needs to challenge the user, for supplemental authorization or account reset, the relying party can use the stored challenge methods, as further described below with respect to FIG. 11.

FIG. 11 shows a flowchart of a procedure to respond to a challenge according to an embodiment of the invention. Referring to FIG. 11, at block 1105, a relying party determines that a user should be challenged. This determination can be prompted by the user requesting an account reset or it can originate with the relying party as part of a supplemental authorization. The relying party retrieves a stored challenge methods claim associated with the user at block 1110. The claim contains a list of challenge methods that are supported by the identity provider that issued the claim. At block 1115, the relying party determines which of the supported challenge methods to use. This determination can be based, in part, on which methods are supported by the relying party. This determination can also be based, in part, on any seed data that has been previously obtained and stored by the relying party. In other words, the relying party can determine if it has sufficient seed data stored to support a particular challenge method, and, if so, the relying party may choose to use the supported challenge method. The relying party can choose to use only a single challenge method or it can choose to use several challenge methods.

Once the challenge methods are selected, the relying party presents a challenge to a client at block 1120. The challenge issued by the relying party can consist of a single challenge method or it can consist of multiple challenge methods. In other words, the relying party can seek a single claim (or set of claims) in response to a single challenge or the relying party can seek multiple claims (or sets of claims) in response to multiple challenges. At block 1125, the user at the client chooses an appropriate information card and the client sends a request for a security token to the corresponding identity provider. The identity provider generates or retrieves the necessary information for the claim(s) and generates the security token at block 1130. Depending on the challenge method(s) used, the identity provider can have the requested information for the claim(s) stored or it can generate the requested information in order to generate the security token. Also, the identity provider can obtain the requested information from another identity provider. At block 1135, the security token is transmitted to the client, which forwards the security token to the relying party.

At block 1140, the relying party validates the claim(s) in the security token against information known to the relying party. The relying party can validate the claim(s) against information that is already stored at the relying party or the relying party can generate the information before it can be validated. At block 1145, the relying party determines if the challenge process is complete. If the relying party determines that the challenge process is not complete, the process returns to block 1120 to issue the next challenge. When the relying party uses more than one challenge method, the relying party can validate the user even if the identity provider is not able to provide proper responses for every challenge method. For example, the user can be validated (i.e. the account reset is accepted or the supplemental authorization is approved) if n correct responses are provided out of m challenge methods. The values of n and m can be determined by the relying party or by the user during account setup, for example.

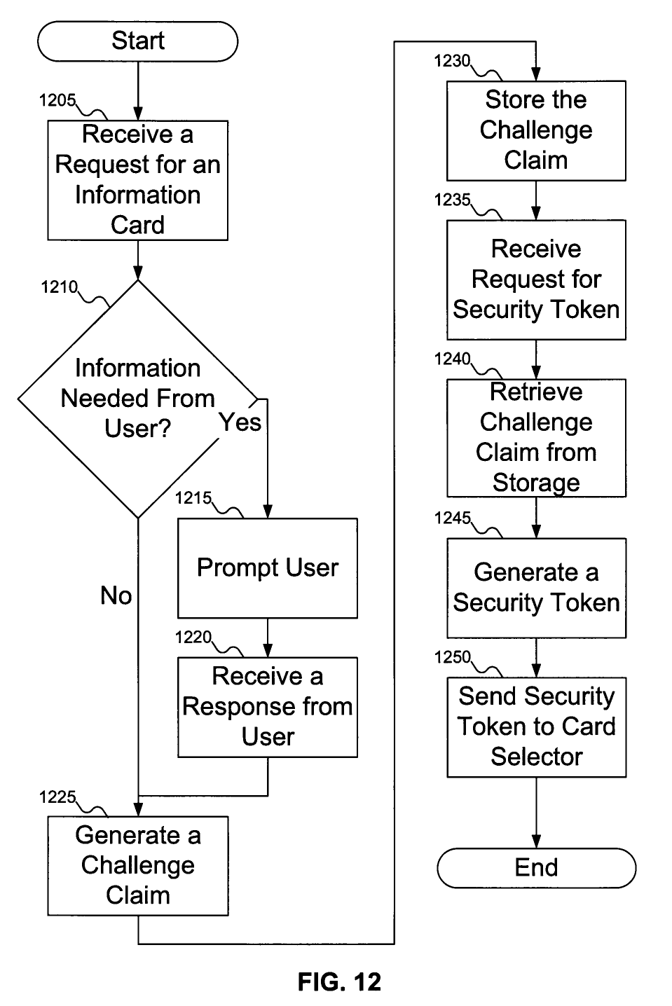

FIG. 12 shows a flowchart of a procedure to generate, store, and provide challenge claims according to an embodiment of the invention. Referring to FIG. 12, at block 1205, a request for a managed information card is received at an identity provider from a card selector. The request can include an identifier indicating a challenge claim method, a simple challenge question, and/or a simple challenge answer. The identity provider determines if it has stored challenge claims that can be associated with the requested managed card, for example, challenge claims that were stored by the identity provider following previous interactions with the user such as account setup. If the identity provider does not have any appropriate challenge claims stored, the identity provider then determines if information is needed from the user in order to generate a challenge claim associated with the managed card at block 1210. When the request includes an identifier indicating a challenge claim method, the identity provider can use the identifier to determine if further information is needed from the user in order to generate a challenge claim appropriate for the indicated challenge claim method. For example, if the identifier indicates a simple challenge question/answer method, the identity provider can determine that it needs one or more simple challenge questions and/or simple challenge answers in order to generate the challenge claim. If the identity provider determines that it does not need any additional information, the method proceeds directly to block 1225 where the challenge claim is generated. Generating the challenge claim at block 1225 can include retrieving the challenge claim from a storage if the identity provider determines that it already has an appropriate challenge claim stored. If the identity provider determines that it needs more information from the user, the identity provider prompts the user for the information at block 1215. At block 1220, the identity provider receives a response from the user including the requested information. The identity provider then generates the challenge claim at block 1225.

Generating the challenge claim can include generating more than one challenge claim and the challenge claim(s) can include a simple challenge answer, a simple challenge question, a generated-challenge answer, a challenge method, and/or challenge method seeds. Generating the challenge claim can also include generating a challenge claim that is specific to a particular relying party. Also, the challenge claim can include a random string of characters. In this case, a random string of characters includes any string of characters or symbols that may or may not form a construct found in a natural language. The challenge claim can be stored at the identity provider at block 1230. The identity provider might not store the challenge claim in the case that it already has the challenge claim stored or in the case that responding to a subsequent challenge will not require retrieval of a stored claim (i.e. the challenge claim can be re-generated by the identity provider as needed). Then, the identity provider sends the requested managed card to the card selector.

At block 1235, the identity provider receives a request for a security token from a card selector. The request can include a challenge claim request identifier. The identity provider retrieves a challenge claim responsive to the request for the security token at block 1240. Retrieving the challenge claim can include retrieving the challenge claim from a storage and it can include generating the challenge claim. Retrieving the stored challenge claim can also include generating challenge method seed data. Also, retrieving the stored challenge claim can include retrieving stored challenge method seed data. At block 1245, the identity provider generates a security token including the challenge claim. The security token can also include challenge method seed data. The security token is then sent to the card selector at block 1250.

According to some embodiments of the invention, a user can request a challenge claim directly from an identity provider. For example, a relying party may prompt the user for a response to a challenge question and the answer to the challenge question can be stored at the identity provider. Therefore, the user can request the challenge claim from the identity provider and then provide the response to the relying party by, for example, pasting the response into a field in a form provided by the relying party.

Although in the above-described procedures the challenge answers and/or methods are stored by the relying party as part of an authentication process, the challenge answers and/or methods could be obtained and stored at any other time including: during initial account setup on the relying party; during a subsequent account update; or upon request from either the user or the relying party. Also, a person of ordinary skill in the art will recognize that the procedures described above can be combined so that multiple claims are used by the relying party. For example, the relying party can obtain and store claims for a simple challenge question and answer and a claim for challenge methods. Further, the claim for challenge methods can include simple challenge question/answer as one of the supported challenge methods. Any other combination of the new claim identifiers is possible.

As described above, information cards can be used to implement account reset and supplemental authorization between users and relying parties. New claim identifiers are used to allow claims to be provided by an identity provider in response to challenges from a relying party. Using these new claim identifiers, the user is not required to remember the answers that were previously given to the challenge questions and the security of the system is not reliant upon publicly available information. Consequently, using information cards for user challenges increases the security of user accounts.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. An apparatus, comprising:
a machine;
a receiver on the machine configured to receive from a relying party a request for at least one challenge claim;
a card selector on the machine configured to receive from a user a selection of an information card responsive to the request for the at least one challenge claim; and
a transmitter configured to transmit to an identity provider a request for a security token responsive to the selection of the information card,
wherein the receiver is further configured to receive the security token from the identity provider, the transmitter is further configured to transmit the security token to the relying party, and the security token includes the at least one challenge claim.

2. An apparatus according to claim 1, wherein the at least one challenge claim includes at least one of a simple challenge question, a simple challenge answer, a generated-challenge answer, a challenge method, and challenge method seed data.

3. An apparatus according to claim 2, wherein one or more of the at least one challenge claims comprises a tuple.

4. A method for obtaining a challenge claim, comprising:
receiving from a client a request for a security policy;
transmitting to the client the security policy, wherein the security policy comprises at least one challenge claim identifier;
receiving from the client a security token, the security token comprising at least one challenge claim; and
storing the at least one challenge claim.

5. A method according to claim 4, wherein receiving the security token comprises receiving a security token including at least one of a simple challenge question, a simple challenge answer, a generated-challenge answer, a challenge method, and challenge method seed data.

6. A method according to claim 5, wherein receiving the security token further comprises receiving a security token including at least one challenge claim comprising a tuple.

7. A method according to claim 5, wherein storing the at least one challenge claim comprises storing an identifier for an identity provider that issued the security token.

8. An article, comprising a storage medium, the storage medium having stored thereon instructions that, when executed by a machine, result in:
receiving from a client a request for a security policy;
transmitting to the client the security policy, wherein the security policy comprises at least one challenge claim identifier;
receiving from the client a security token, the security token comprising at least one challenge claim; and
storing the at least one challenge claim.

9. An article according to claim 8, wherein the at least one challenge claim includes at least one of a simple challenge question, a simple challenge answer, a generated-challenge answer, a challenge method, and challenge method seed data.

10. An article according to claim 8, wherein the at least one challenge claim comprises a tuple.

11. A method for responding to a challenge from a relying party, comprising:
receiving the challenge from the relying party;
obtaining a response to the challenge from an identity provider; and
providing the response to the relying party.

12. A method according to claim 11, wherein:
obtaining the response to the challenge comprises requesting a security token from the identity provider; and
providing the response to the relying party comprises providing the security token to the relying party.

13. A method according to claim 11, wherein:
the method further comprises requesting an account reset; and
receiving the challenge includes receiving the challenge from the relying party responsive to the account reset request.

14. A method according to claim 11, further comprising repeatedly receiving a challenge, obtaining a response, and providing the response to the relying party for at least two iterations.

15. A method according to claim 14, wherein obtaining a response in a first one of the at least two iterations comprises obtaining a response from a first identity provider and wherein obtaining a response in a second one of the at least two iterations comprises obtaining a response from a second identity provider.

16. An article, comprising a storage medium, the storage medium having stored thereon instructions that, when executed by a machine, result in:
receiving a challenge from a relying party;
obtaining a response to the challenge from an identity provider; and
providing the response to the relying party.

17. An article according to claim 16, wherein:
obtaining the response to the challenge comprises requesting a security token from the identity provider; and
providing the response to the relying party comprises providing the security token to the relying party.

18. An article according to claim 16, wherein:
the storage medium has stored thereon further instructions that, when executed by the machine, result in:
requesting an account reset before receiving the challenge from the relying party.

19. An article according to claim 16, wherein:
the storage medium has stored thereon further instructions that, when executed by the machine, result in:
repeatedly receiving a challenge, obtaining a response, and providing the response to the relying party for at least two iterations.

20. A method for challenging a user, comprising:
determining that the user is to be challenged;
retrieving a stored list of challenge methods associated with the user;
identifying a first challenge method from the list of challenge methods;
providing a first challenge to the user based upon the first challenge method;
receiving a first response from the user; and
validating the first response.

21. A method according to claim 20, further comprising:
identifying a second challenge method from the list of challenge methods;
providing a second challenge to the user based upon the second challenge method;
receiving a second response from the user; and
validating the second response.

22. A method according to claim 21, wherein:
receiving the first response comprises receiving a response generated by a first identity provider; and
receiving the second response comprises receiving a response generated by a second identity provider.

23. A method according to claim 20, wherein validating the first response comprises:
retrieving a stored answer; and
comparing the stored answer with the first response.

24. A method according to claim 20, wherein validating the first response comprises:
generating an answer; and
comparing the answer with the first response.

25. A method according to claim 20, wherein determining that the user is to be challenged comprises receiving a request for an account reset from the user.

26. An article, comprising a storage medium, the storage medium having stored thereon instructions that, when executed by a machine, result in:
determining that a user is to be challenged;
retrieving a stored list of challenge methods associated with the user;
identifying a first challenge method from the list of challenge methods;
providing a first challenge to the user based upon the first challenge method;
receiving a first response from the user; and
validating the first response.

27. An article according to claim 26, wherein:
the storage medium has stored thereon further instructions that, when executed by the machine, result in:
identifying a second challenge method from the list of challenge methods;
providing a second challenge to the user based upon the second challenge method;
receiving a second response from the user; and
validating the second response.

28. An article according to claim 27, wherein:
receiving the first response comprises receiving a response generated by a first identity provider; and
wherein receiving the second response comprises receiving a response generated by a second identity provider.

29. An article according to claim 26, wherein validating the first response comprises:
retrieving a stored answer; and
comparing the stored answer with the first response.

30. An article according to claim 26, wherein validating the first response comprises:
generating an answer; and
comparing the answer with the first response.

31. A method, comprising:
receiving a request for an information card from a client;
obtaining at least one challenge claim responsive to the request; and
sending the information card to the client, wherein the information card includes at least one challenge claim identifier.

32. A method according to claim 31, wherein obtaining the at least one challenge claim comprises one of generating at least one of a simple challenge question, a simple challenge answer, a generated-challenge answer, a challenge method, and challenge method seed data and retrieving the at least one challenge claim from a storage.

33. A method according to claim 31, wherein obtaining the at least one challenge claim comprises:
prompting a user for at least one of an identifier for a challenge claim method, a simple challenge question, and a simple challenge answer; and
receiving a response from the user including at least one of the identifier for the challenge claim method, the simple challenge question, and the simple challenge answer.

34. A method according to claim 31, wherein obtaining the at least one challenge claim comprises generating at least one challenge claim that is specific to a relying party.

35. A method according to claim 31, wherein obtaining the at least one challenge claim comprises generating at least one challenge claim including a random string of characters.

36. A method according to claim 31, further comprising:
receiving a request for a security token from the card selector, the request including a challenge claim request identifier;
retrieving the at least one challenge claim;
generating a security token, the security token including the at least one challenge claim; and
sending the security token to the card selector.

37. A method according to claim 36, wherein retrieving the at least one challenge claim comprises generating challenge method seed data and wherein generating the security token comprises generating a security token including the challenge method seed data.

38. A method according to claim 36, wherein retrieving the at least one challenge claim comprises retrieving stored challenge method seed data and wherein generating the security token comprises generating a security token including the stored challenge method seed data.

39. A method according to claim 31, further comprising:
receiving a request for the at least one challenge claim from a user;
retrieving the at least one challenge claim;
presenting the at least one challenge claim to the user.

40. A method according to claim 39, wherein presenting the at least one challenge claim to the user comprises presenting at least one of a simple challenge answer and a generated challenge answer to the user.
